(19) United States
(12) Patent Application Publication
(10) Pub. No.: US 2026/0205940 A1
(43) Pub. Date: Jul. 16, 2026

(54) SYSTEMS AND METHODS TO HANDLE EMERGENCY EVENTS IN DIGITAL DISTRIBUTED ANTENNA SYSTEMS

(71) Applicant: Outdoor Wireless Networks LLC, Richardson, TX (US)

(72) Inventor: Harsha Hegde, Hawthorn Woods, IL (US)

(73) Assignee: Outdoor Wireless Networks LLC, Richardson, TX (US)

(21) Appl. No.: 19/136,228

(22) PCT Filed: Dec. 1, 2023
(86) PCT No.: PCT/US2023/082059

§ 371 Date: Jun. 5, 2025

Related U.S. Application Data
(60) Provisional application No. 63/386,110, filed on Dec. 5, 2022.

(51) Int. Cl. H04W 52/02

(52) U.S. Cl. CPC H04W 52/0203

(57) ABSTRACT

Systems and methods for handling emergency events in a digital distributed antenna system are provided. In one example, a method includes determining a type of active alert for a distributed antenna system. The method further includes determining one or more paths of the distributed antenna system impacted by the active alert. The method further includes adjusting operation of one or more components of the distributed antenna system based on the determined type of active alert and the determined one or more paths of the distributed antenna system impacted by the active alert.

### CROSS-REFERENCE TO RELATED APPLICATIONS

This application claims priority to U.S. Provisional Application No. 63/386,110, filed on Dec. 5, 2022, and titled “SYSTEMS AND METHODS TO HANDLE EMERGENCY EVENTS IN DIGITAL DISTRIBUTED ANTENNA SYSTEMS,” the contents of which are incorporated by reference herein in their entirety.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote units”), where each access point can be coupled directly to one or more of the central access nodes or indirectly via one or more other remote units and/or via one or more intermediary or expansion units or nodes (also referred to here as “transport expansion nodes (TENs)”). A DAS is typically used to improve the coverage provided by one or more base stations that are coupled to the central access nodes. These base stations can be coupled to the one or more central access nodes via one or more cables or via a wireless connection, for example, using one or more donor antennas. The wireless service provided by the base stations can include commercial cellular service and/or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals that are radiated from one or more coverage antennas associated with that access point. The downlink radio frequency signals are radiated for reception by user equipment (UEs). Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits them to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, this involves, among other things, summing uplink signals received from all of the multiple access points in order to produce the base station signal provided to each base station. In this way, the DAS increases the coverage area for the uplink capacity provided by the base stations.

A DAS can use either digital transport, analog transport, or combinations of digital and analog transport for generating and communicating the transport signals between the central access nodes, the access points, and any transport expansion nodes.

### SUMMARY

In one aspect, a method includes determining a type of active alert for a distributed antenna system. The method further includes determining one or more paths of the distributed antenna system impacted by the active alert. The method further includes adjusting operation of one or more components of the distributed antenna system based on the determined type of active alert and the determined one or more paths of the distributed antenna system impacted by the active alert.

In another aspect, a system includes a master unit of a distributed antenna system, wherein the master unit is configured to be coupled to one or more baseband unit entities. The system further includes a plurality of radio units of the distributed antenna system communicatively coupled to the master unit, wherein the plurality of radio units is located remotely from the master unit. The system further includes at least one controller communicatively coupled to the master unit and the plurality of radio units. One or more components of the system are configured to determine a type of active alert for the distributed antenna system; determine one or more distribution paths of the distributed antenna system impacted by the active alert; and adjust operation of one or more components of the distributed antenna system based on the determined type of active alert and the determined one or more paths of the distributed antenna system impacted by the active alert.

### BRIEF DESCRIPTION OF THE DRAWINGS

Comprehension of embodiments of the invention is facilitated by reading the following detailed description in conjunction with the annexed drawings, in which:

FIG. 1A is a block diagram illustrating an exemplary embodiment of a distributed antenna system (DAS) that is configured to serve one or more base stations;

FIG. 1B illustrates another exemplary embodiment of a DAS;

FIG. 1C illustrates another exemplary embodiment of a DAS;

FIG. 1D illustrates another exemplary embodiment of a DAS;

FIG. 2 illustrates another exemplary embodiment of a DAS;

FIG. 3 is a flow diagram of an example method of alert management in a DAS; and

FIGS. 4A-4B illustrate example messages for use in alert management in a DAS.

### DETAILED DESCRIPTION

In the following detailed description, reference is made to the accompanying drawings that form a part hereof, and in which is shown by way of illustration specific illustrative embodiments. However, it is to be understood that other embodiments may be used, and that logical, mechanical, and electrical changes may be made. Furthermore, the method presented in the drawing figures and the specification is not to be construed as limiting the order in which the individual acts may be performed. The following detailed description is, therefore, not to be taken in a limiting sense.

In a fifth generation (5G) New Radio (NR) network, digital signals may be distributed via a digital DAS to overcome coverage or capacity constraints. These digitals signals are distributed via a packet transport network and a set of compute nodes that is generally optimized to support traffic for normal circumstances and to meet end-to-end Service Level Agreements (SLAs). However, during emergencies (for example, E911 calls, Earthquake and Tsunami Warning System (ETWS) alerts, Commercial Mobile Alert System (CMAS) alerts, weather alerts, etc.), the needs for distribution of the traffic using a DAS and the available resources can be different from normal circumstances. DAS network nodes and management systems do not typically adjust operation for emergency situations to ensure service availability with increased demand using available resources.

While the problems described above involve 5G NR systems, similar problems exist in LTE. Therefore, although the following embodiments are primarily described as being implemented for use to provide 5G NR service, it is to be understood the techniques described here can be used with other wireless interfaces (for example, fourth generation (4G) Long-Term Evolution (LTE) service) and references to “gNB” can be replaced with the more general term “base station” or “base station entity” and/or a term particular to the alternative wireless interfaces (for example, “enhanced NodeB” or “eNB”). Furthermore, it is also to be understood that 5G NR embodiments can be used in both standalone and non-standalone modes (or other modes developed in the future), and the following description is not intended to be limited to any particular mode. Also, unless explicitly indicated to the contrary, references to “layers” or a “layer” (for example, Layer-1, Layer-2, Layer-3, the Physical Layer, the MAC Layer, etc.) set forth herein refer to layers of the wireless interface (for example, 5G NR or 4G LTE) used for wireless communication between a base station and user equipment).

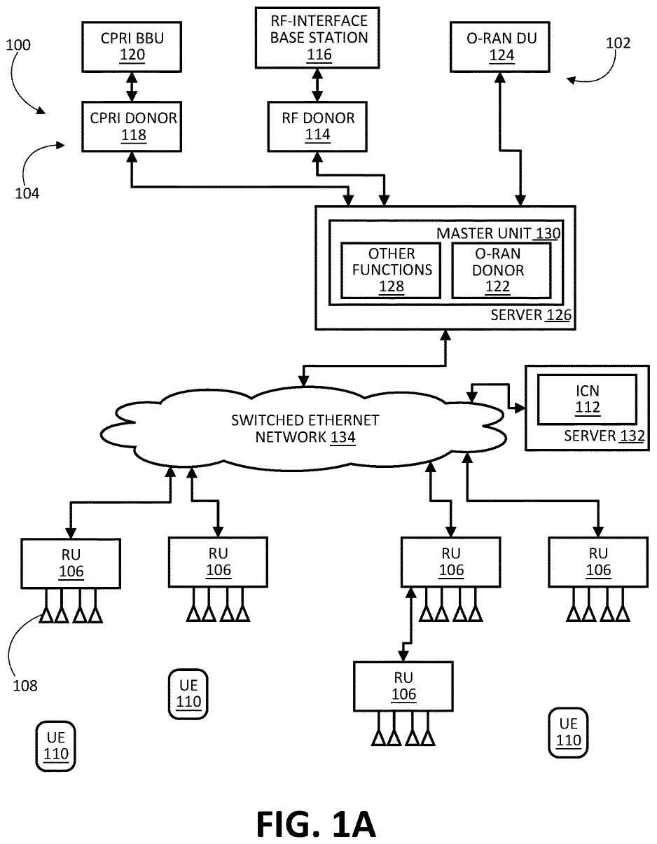

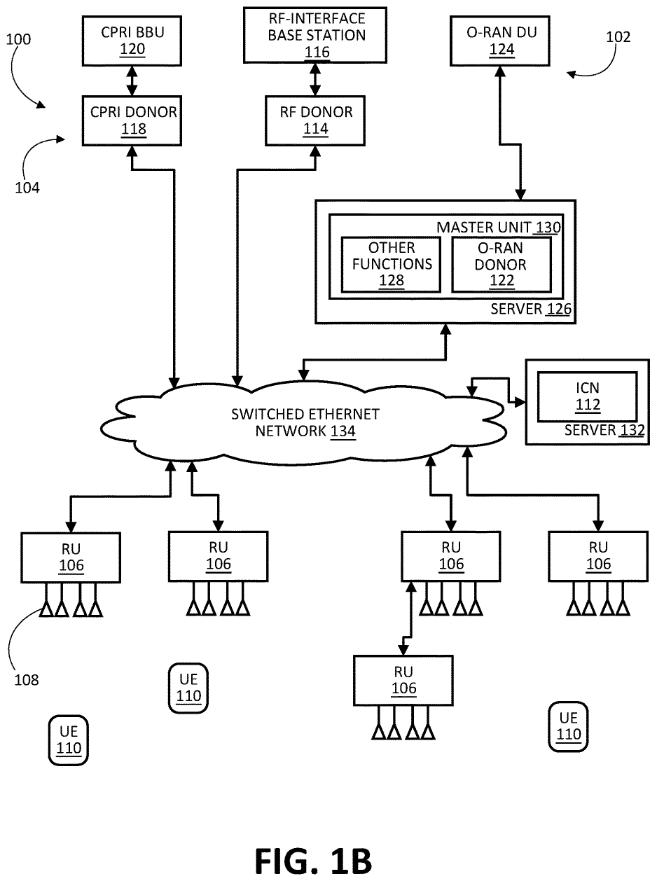

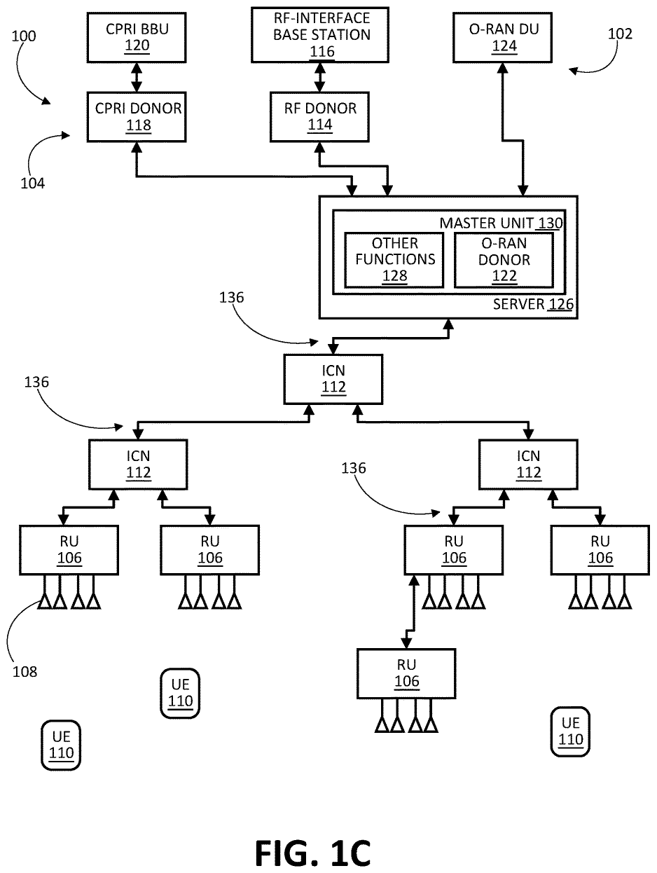

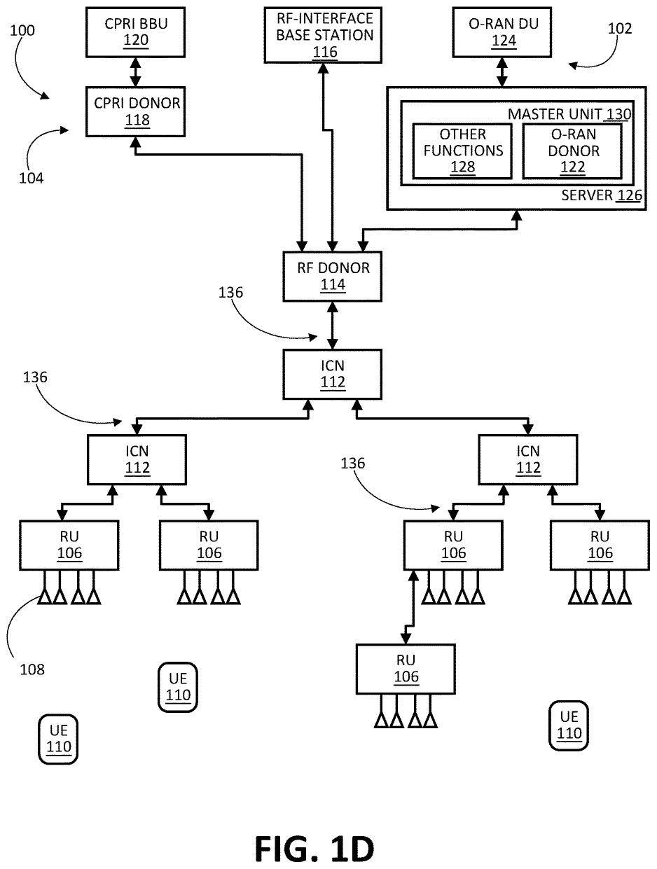

FIG. 1A is a block diagram illustrating an exemplary embodiment of a distributed antenna system (DAS) 100 that is configured to serve one or more base stations 102. In the exemplary embodiment shown in FIG. 1A, the DAS 100 includes one or more donor units 104 that are used to couple the DAS 100 to the base stations 102. The DAS 100 also includes a plurality of remotely located radio units (RUs) 106 (also referred to as “antenna units,” “access points,” “remote units,” or “remote antenna units”). The RUs 106 are communicatively coupled to the donor units 104.

Each RU 106 includes, or is otherwise associated with, a respective set of coverage antennas 108 via which downlink analog RF signals can be radiated to user equipment (UEs) 110 and via which uplink analog RF signals transmitted by UEs 110 can be received. The DAS 100 is configured to serve each base station 102 using a respective subset of RUs 106 (which may include less than all of the RUs 106 of the DAS 100). Also, the subsets of RUs 106 used to serve the base stations 102 may differ from base station 102 to base station 102. The subset of RUs 106 used to serve a given base station 102 is also referred to here as the “simulcast zone” for that base station 102. In general, the wireless coverage of a base station 102 served by the DAS 100 is improved by radiating a set of downlink RF signals for that base station 102 from the coverage antennas 108 associated with the multiple RUs 106 in that base station's stations simulcast zone and by producing a single “combined” set of uplink base station signals or data that is provided to that base station 102. The single combined set of uplink base station signals or data is produced by a combining or summing process that uses inputs derived from the uplink RF signals received via the coverage antennas 108 associated with the RUs 106 in that base station's simulcast zone.

The DAS 100 can also include one or more intermediary combining nodes (ICNs) 112 (also referred to as “expansion” units or nodes). For each base station 102 served by a given ICN 112, the ICN 112 is configured to receive a set of uplink transport data for that base station 102 from a group of “southbound” entities (that is, from RUs 106 and/or other ICNs 112) and generate a single set of combined uplink transport data for that base station 102, which the ICN 112 transmits “northbound” towards the donor unit 104 serving that base station 102. The single set of combined uplink transport data for each served base station 102 is produced by a combining or summing process that uses inputs derived from the uplink RF signals received via the coverage antennas 108 of any southbound RUs 106 included in that base station's simulcast zone. As used here, “southbound” refers to traveling in a direction “away,” or being relatively “farther,” from the donor units 104 and base stations 102, and “northbound” refers to traveling in a direction “towards,” or being relatively “closer” to, the donor units 104 and base stations 102.

In some configurations, each ICN 112 also forwards downlink transport data to the group of southbound RUs 106 and/or ICNs 112 served by that ICN 112. Generally, ICNs 112 can be used to increase the number of RUs 106 that can be served by the donor units 104 while reducing the processing and bandwidth load relative to having the additional RUs 106 communicate directly with each such donor unit 104.

Also, one or more RUs 106 can be configured in a “daisy-chain” or “ring” configuration in which transport data for at least some of those RUs 106 is communicated via at least one other RU 106. Each RU 106 would also perform the combining or summing process for any base station 102 that is served by that RU 106 and one or more of the southbound entities subtended from that RU 106. Such a RU 106 also forwards northbound all other uplink transport data received from its southbound entities.

The DAS 100 can include various types of donor units 104. One example of a donor unit 104 is an RF donor unit 114 that is configured to couple the DAS 100 to a base station 116 using the external analog radio frequency (RF) interface of the base station 116 that would otherwise be used to couple the base station 116 to one or more antennas (if the DAS 100 were not being used). This type of base station 116 is also referred to here as an “RF-interface” base station 116. An RF-interface base station 116 can be coupled to a corresponding RF donor unit 114 by coupling each antenna port of the base station 116 to a corresponding port of the RF donor unit 114.

Each RF donor unit 114 serves as an interface between each served RF-interface base station 116 and the rest of the DAS 100 and receives downlink base station signals from, and outputs uplink base station signals to, each served RF-interface base station 116. Each RF donor unit 114 performs at least some of the conversion processing necessary to convert the base station signals to and from the digital fronthaul interface format natively used in the DAS 100 for communicating time-domain baseband data. The downlink and uplink base station signals communicated between the RF-interface base station 116 and the donor unit 114 are analog RF signals. Also, in this example, the digital fronthaul interface format natively used in the DAS 100 for communicating time-domain baseband data can comprise the O-RAN fronthaul interface, a CPRI or enhanced CPRI (eCPRI) digital fronthaul interface format, or a proprietary digital fronthaul interface format (though other digital fronthaul interface formats can also be used).

Another example of a donor unit 104 is a digital donor unit that is configured to communicatively couple the DAS 100 to a baseband entity using a digital baseband fronthaul interface that would otherwise be used to couple the baseband entity to a radio unit (if the DAS 100 were not being used). In the example shown in FIG. 1A, two types of digital door units are shown.

The first type of digital donor unit comprises a digital donor unit 118 that is configured to communicatively couple the DAS 100 to a baseband unit (BBU) 120 using a time-domain baseband fronthaul interface implemented in accordance with a Common Public Radio Interface (“CPRI”) specification. This type of digital donor unit 118 is also referred to here as a “CPRI” donor unit 118, and this type of BBU 120 is also referred to here as a CPRI BBU 120. For each CPRI BBU 120 served by a CPRI donor unit 118, the CPRI donor unit 118 is coupled to the CPRI BBU 120 using the CPRI digital baseband fronthaul interface that would otherwise be used to couple the CPRI BBU 120 to a CPRI remote radio head (RRH) (if the DAS 100 were not being used). A CPRI BBU 120 can be coupled to a corresponding CPRI donor unit 118 via a direct CPRI connection.

Each CPRI donor unit 118 serves as an interface between each served CPRI BBU 120 and the rest of the DAS 100 and receives downlink base station signals from, and outputs uplink base station signals to, each CPRI BBU 120. Each CPRI donor unit 118 performs at least some of the conversion processing necessary to convert the CPRI base station data to and from the digital fronthaul interface format natively used in the DAS 100 for communicating time-domain baseband data. The downlink and uplink base station signals communicated between each CPRI BBU 120 and the CPRI donor unit 118 comprise downlink and uplink fronthaul data generated and formatted in accordance with the CPRI baseband fronthaul interface.

The second type of digital donor unit comprises a digital donor unit 122 that is configured to communicatively couple the DAS 100 to a BBU 124 using a frequency-domain baseband fronthaul interface implemented in accordance with a O-RAN Alliance specification. The acronym “O-RAN” is an abbreviation for “Open Radio Access Network.” This type of digital donor unit 122 is also referred to here as an “O-RAN” donor unit 122, and this type of BBU 124 is typically an O-RAN distributed unit (DU) and is also referred to here as an O-RAN DU 124. For each O-RAN DU 124 served by a O-RAN donor unit 122, the O-RAN donor unit 122 is coupled to the O-DU 124 using the O-RAN digital baseband fronthaul interface that would otherwise be used to couple the O-RAN DU 124 to a O-RAN RU (if the DAS 100 were not being used). An O-RAN DU 124 can be coupled to a corresponding O-RAN donor unit 122 via a switched Ethernet network. Alternatively, an O-RAN DU 124 can be coupled to a corresponding O-RAN donor unit 122 via a direct Ethernet or CPRI connection.

Each O-RAN donor unit 122 serves as an interface between each served O-RAN DU 124 and the rest of the DAS 100 and receives downlink base station signals from, and outputs uplink base station signals to, each O-RAN DU 124. Each O-RAN donor unit 122 performs at least some of any conversion processing necessary to convert the base station signals to and from the digital fronthaul interface format natively used in the DAS 100 for communicating frequency-domain baseband data. The downlink and uplink base station signals communicated between each O-RAN DU 124 and the O-RAN donor unit 122 comprise downlink and uplink fronthaul data generated and formatted in accordance with the O-RAN baseband fronthaul interface, where the user-plane data comprises frequency-domain baseband IQ data. Also, in this example, the digital fronthaul interface format natively used in the DAS 100 for communicating O-RAN fronthaul data is the same O-RAN fronthaul interface used for communicating base station signals between each O-RAN DU 124 and the O-RAN donor unit 122, and the “conversion” performed by each O-RAN donor unit 122 (and/or one or more other entities of the DAS 100) includes performing any needed “multicasting” of the downlink data received from each O-RAN DU 124 to the multiple RUs 106 in a simulcast zone for that O-RAN DU 124 (for example, by communicating the downlink fronthaul data to an appropriate multicast address and/or by copying the downlink fronthaul data for communication over different fronthaul links) and performing any need combining or summing of the uplink data received from the RUs 106 to produce combined uplink data provided to the O-RAN DU 124. It is to be understood that other digital fronthaul interface formats can also be used.

In general, the various base stations 102 are configured to communicate with a core network (not shown) of the associated wireless operator using an appropriate backhaul network (typically, a public wide area network such as the Internet). Also, the various base stations 102 may be from multiple, different wireless operators and/or the various base stations 102 may support multiple, different wireless protocols and/or RF bands.

In general, for each base station 102, the DAS 100 is configured to receive a set of one or more downlink base station signals from the base station 102 (via an appropriate donor unit 104), generate downlink transport data derived from the set of downlink base station signals, and transmit the downlink transport data to the RUs 106 in the base station's simulcast zone. For each base station 102 served by a given RU 106, the RU 106 is configured to receive the downlink transport data transmitted to it via the DAS 100 and use the received downlink transport data to generate one or more downlink analog radio frequency signals that are radiated from one or more coverage antennas 108 associated with that RU 106 for reception by user equipment 110. In this way, the DAS 100 increases the coverage area for the downlink capacity provided by the base stations 102. Also, for any southbound entities (for example, southbound RUs 106 or ICNs 112) coupled to the RU 106 (for example, in a daisy chain or ring architecture), the RU 106 forwards any downlink transport data intended for those southbound entities towards them.

For each base station 102 served by a given RU 106, the RU 106 is configured to receive one or more uplink radio frequency signals transmitted from the user equipment 110. These signals are analog radio frequency signals and are received via the coverage antennas 108 associated with that RU 106. The RU 106 is configured to generate uplink transport data derived from the one or more remote uplink radio frequency signals received for the served base station 102 and transmit the uplink transport data northbound towards the donor unit 104 coupled to that base station 102.

For each base station 102 served by the DAS 100, a single “combined” set of uplink base station signals or data is produced by a combining or summing process that uses inputs derived from the uplink RF signals received via the RUs 106 in that base station's simulcast zone. The resulting final single combined set of uplink base station signals or data is provided to the base station 102. This combining or summing process can be performed in a centralized manner in which the combining or summing process is performed by a single unit of the DAS 100 (for example, a donor unit 104 or master unit 130). This combining or summing process can also be performed in a distributed or hierarchical manner in which the combining or summing process is performed by multiple units of the DAS 100 (for example, a donor unit 104 (or master unit 130) and one or more ICNs 112 and/or RUs 106). Each unit of the DAS 100 that performs the combining or summing process for a given base station 102 receives uplink transport data from that unit's southbound entities and uses that data to generate combined uplink transport data, which the unit transmits northbound towards the base station 102. The generation of the combined uplink transport data involves, among other things, extracting in-phase and quadrature (IQ) data from the received uplink transport data and performing a combining or summing process using any uplink IQ data for that base station 102 in order to produce combined uplink IQ data.

Some of the details regarding how base station signals or data are communicated and transport data is produced vary based on which type of base station 102 is being served. In the case of an RF-interface base station 116, the associated RF donor unit 114 receives analog downlink RF signals from the RF-interface base station 116 and, either alone or in combination with one or more other units of the DAS 100, converts the received analog downlink RF signals to the digital fronthaul interface format natively used in the DAS 100 for communicating time-domain baseband data (for example, by digitizing, digitally down-converting, and filtering the received analog downlink RF signals in order to produce digital baseband IQ data and formatting the resulting digital baseband IQ data into packets) and communicates the resulting packets of downlink transport data to the various RUs 106 in the simulcast zone of that base station 116. The RUs 106 in the simulcast zone for that base station 116 receive the downlink transport data and use it to generate and radiate downlink RF signals as described above. In the uplink, either alone or in combination with one or more other units of the DAS 100, the RF donor unit 114 generates a set of uplink base station signals from uplink transport data received by the RF donor unit 114 (and/or the other units of the DAS 100 involved in this process). The set of uplink base station signals is provided to the served base station 116. The uplink transport data is derived from the uplink RF signals received at the RUs 106 in the simulcast zone of the served base station 116 and communicated in packets.

In the case of a CPRI BBU 120, the associated CPRI digital donor unit 118 receives CPRI downlink fronthaul data from the CPRI BBU 120 and, either alone or in combination with another unit of the DAS 100, converts the received CPRI downlink fronthaul data to the digital fronthaul interface format natively used in the DAS 100 for communicating time-domain baseband data (for example, by re-sampling, synchronizing, combining, separating, gain adjusting, etc. the CPRI baseband IQ data, and formatting the resulting baseband IQ data into packets), and communicates the resulting packets of downlink transport data to the various RUs 106 in the simulcast zone of that CPRI BBU 120. The RUs 106 in the simulcast zone of that CPRI BBU 120 receive the packets of downlink transport data and use them to generate and radiate downlink RF signals as described above. In the uplink, either alone or in combination with one or more other units of the DAS 100, the CPRI donor unit 118 generates uplink base station data from uplink transport data received by the CPRI donor unit 118 (and/or the other units of the DAS 100 involved in this process). The resulting uplink base station data is provided to that CPRI BBU 120. The uplink transport data is derived from the uplink RF signals received at the RUs 106 in the simulcast zone of the CPRI BBU 120.

In the case of an O-RAN DU 124, the associated O-RAN donor unit 122 receives packets of O-RAN downlink fronthaul data (that is, O-RAN user-plane and control-plane messages) from each O-RAN DU 124 coupled to that O-RAN digital donor unit 122 and, either alone or in combination with another unit of the DAS 100, converts (if necessary) the received packets of O-RAN downlink fronthaul data to the digital fronthaul interface format natively used in the DAS 100 for communicating O-RAN baseband data and communicates the resulting packets of downlink transport data to the various RUs 106 in a simulcast zone for that ORAN DU 124. The RUs 106 in the simulcast zone of each O-RAN DU 124 receive the packets of downlink transport data and use them to generate and radiate downlink RF signals as described above. In the uplink, either alone or in combination with one or more other units of the DAS 100, the O-RAN donor unit 122 generates packets of uplink base station data from uplink transport data received by the O-RAN donor unit 122 (and/or the other units of the DAS 100 involved in this process). The resulting packets of uplink base station data are provided to the O-RAN DU 124. The uplink transport data is derived from the uplink RF signals received at the RUs 106 in the simulcast zone of the served O-RAN DU 124 and communicated in packets.

In one implementation, one of the units of the DAS 100 is also used to implement a “master” timing entity for the DAS 100 (for example, such a master timing entity can be implemented as a part of a master unit 130 described below). In another example, a separate, dedicated timing master entity (not shown) is provided within the DAS 100. In either case, the master timing entity synchronizes itself to an external timing master entity (for example, a timing master associated with one or more of the O-DUs 124) and, in turn, that entity serves as a timing master entity for the other units of the DAS 100. A time synchronization protocol (for example, the Institute of Electrical and Electronics Engineers (IEEE) 1588 Precision Time Protocol (PTP), the Network Time Protocol (NTP), or the Synchronous Ethernet (SyncE) protocol) can be used to implement such time synchronization

A management system (not shown) can be used to manage the various nodes of the DAS 100. In one implementation, the management system communicates with a predetermined “master” entity for the DAS 100 (for example, the master unit 130 described below), which in turns forwards or otherwise communicates with the other units of the DAS 100 for management-plane purposes. In another implementation, the management system communicates with the various units of the DAS 100 directly for management-plane purposes (that is, without using a master entity as a gateway).

Each base station 102 (including each RF-interface base station 116, CPRI BBU 120, and O-RAN DU 124), donor unit 104 (including each RF donor unit 114, CPRI donor unit 118, and O-RAN donor unit 122), RU 106, ICN 112, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.). Such entities can be implemented in other ways.

The DAS 100 can be implemented in a virtualized manner or a non-virtualized manner. When implemented in a virtualized manner, one or more nodes, units, or functions of the DAS 100 are implemented using one or more virtual network functions (VNFs) executing on one or more physical server computers (also referred to here as “physical servers” or just “servers”) (for example, one or more commercial-off-the-shelf (COTS) servers of the type that are deployed in data centers or “clouds” maintained by enterprises, communication service providers, or cloud services providers). More specifically, in the exemplary embodiment shown in FIG. 1A, each O-RAN donor unit 122 is implemented as a VNF running on a server 126. The server 126 can execute other VNFs 128 that implement other functions for the DAS 100 (for example, fronthaul, management plane, and synchronization plane functions). The various VNFs executing on the server 126 are also referred to here as “master unit” functions 130 or, collectively, as the “master unit” 130. Also, in the exemplary embodiment shown in FIG. 1A, each ICN 112 is implemented as a VNF running on a server 132.

The RF donor units 114 and CPRI donor units 118 can be implemented as cards (for example, Peripheral Component Interconnect (PCI) Cards) that are inserted in the server 126. Alternatively, the RF donor units 114 and CPRI donor units 118 can be implemented as separate devices that are coupled to the server 126 via dedicated Ethernet links or via a switched Ethernet network (for example, the switched Ethernet network 134 described below).

In the exemplary embodiment shown in FIG. 1A, the donor units 104, RUs 106 and ICNs 112 are communicatively coupled to one another via a switched Ethernet network 134. Also, in the exemplary embodiment shown in FIG. 1A, an O-RAN DU 124 can be coupled to a corresponding O-RAN donor unit 122 via the same switched Ethernet network 134 used for communication within the DAS 100 (though each O-RAN DU 124 can be coupled to a corresponding O-RAN donor unit 122 in other ways). In the exemplary embodiment shown in FIG. 1A, the downlink and uplink transport data communicated between the units of the DAS 100 is formatted as O-RAN data that is communicated in Ethernet packets over the switched Ethernet network 134.

In the exemplary embodiment shown in FIG. 1A, the RF donor units 114 and CPRI donor units 118 are coupled to the RUs 106 and ICNs 112 via the master unit 130.

In the downlink, the RF donor units 114 and CPRI donor units 118 provide downlink time-domain baseband IQ data to the master unit 130. The master unit 130 generates downlink O-RAN user-plane messages containing downlink baseband IQ that is either the time-domain baseband IQ data provided from the donor units 114 and 118 or is derived therefrom (for example, where the master unit 130 converts the received time-domain baseband IQ data into frequency-domain baseband IQ data). The master unit 130 also generates corresponding downlink O-RAN control-plane messages for those O-RAN user-plane messages. The resulting downlink O-RAN user-plane and control-plane messages are communicated (multicasted) to the RUs 106 in the simulcast zone of the corresponding base station 102 via the switched Ethernet network 134.

In the uplink, for each RF-interface base station 116 and CPRI BBU 120, the master unit 130 receives O-RAN uplink user-plane messages for the base station 116 or CPRI BBU 120 and performs a combining or summing process using the uplink baseband IQ data contained in those messages in order to produce combined uplink baseband IQ data, which is provided to the appropriate RF donor unit 114 or CPRI donor unit 118. The RF donor unit 114 or CPRI donor unit 118 uses the combined uplink baseband IQ data to generate a set of base station signals or CPRI data that is communicated to the corresponding RF-interface base station 116 or CPRI BBU 120. If time-domain baseband IQ data has been converted into frequency-domain baseband IQ data for transport over the DAS 100, the donor unit 114 or 118 also converts the combined uplink frequency-domain IQ data into combined uplink time-domain IQ data as part of generating the set of base station signals or CPRI data that is communicated to the corresponding RF-interface base station 116 or CPRI BBU 120.

In the exemplary embodiment shown in FIG. 1A, the master unit 130 (more specifically, the O-RAN donor unit 122) receives downlink O-RAN user-plane and control-plane messages from each served O-RAN DU 124 and communicates (multicasts) them to the RUs 106 in the simulcast zone of the corresponding O-RAN DU 124 via the switched Ethernet network 134. In the uplink, the master unit 130 (more specifically, the O-RAN donor unit 122) receives O-RAN uplink user-plane messages for each served O-RAN DU 124 and performs a combining or summing process using the uplink baseband IQ data contained in those messages in order to produce combined uplink IQ data. The O-RAN donor unit 122 produces O-RAN uplink user-plane messages containing the combined uplink baseband IQ data and communicates those messages to the O-RAN DU 124.

In the exemplary embodiment shown in FIG. 1A, only uplink transport data is communicated using the ICNs 112, and downlink transport data is communicated from the master unit 130 to the RUs 106 without being forwarded by, or otherwise communicated using, the ICNs 112.

FIG. 1B illustrates another exemplary embodiment of a DAS 100. The DAS 100 shown in FIG. 1B is the same as the DAS 100 shown in FIG. 1A except as described below. In the exemplary embodiment shown in FIG. 1B, the RF donor units 114 and CPRI donor units 118 are coupled directly to the switched Ethernet network 134 and not via the master unit 130, as is the case in the embodiment shown in FIG. 1A.

As described above, in the exemplary embodiment shown in FIG. 1A, the master unit 130 performs some transport functions related to serving the RF-interface base stations 116 and CPRI BBUs 120 coupled to the donor units 114 and 118. In the exemplary embodiment shown in FIG. 1B, the RF donor units 114 and CPRI donor units 118 perform those transport functions (that is, the RF donor units 114 and CPRI donor units 118 perform all of the transport functions related to serving the RF-interface base stations 116 and CPRI BBUs 120, respectively).

FIG. 1C illustrates another exemplary embodiment of a DAS 100. The DAS 100 shown in FIG. 1C is the same as the DAS 100 shown in FIG. 1A except as described below. In the exemplary embodiment shown in FIG. 1C, the donor units 104, RUs 106 and ICNs 112 are communicatively coupled to one another via point-to-point Ethernet links 136 (instead of a switched Ethernet network). Also, in the exemplary embodiment shown in FIG. 1C, an O-RAN DU 124 can be coupled to a corresponding O-RAN donor unit 122 via a switched Ethernet network (not shown in FIG. 1C), though that switched Ethernet network is not used for communication within the DAS 100. In the exemplary embodiment shown in FIG. 1C, the downlink and uplink transport data communicated between the units of the DAS 100 is communicated in Ethernet packets over the point-to-point Ethernet links 136.

For each southbound point-to-point Ethernet link 136 that couples a master unit 130 to an ICN 112, the master unit 130 assembles downlink transport frames and communicates them in downlink Ethernet packets to the ICN 112 over the point-to-point Ethernet link 136. For each point-to-point Ethernet link 136, each downlink transport frame multiplexes together downlink time-domain baseband IQ data and Ethernet data that needs to be communicated to southbound RUs 106 and ICNs 112 that are coupled to the master unit 130 via that point-to-point Ethernet link 136. The downlink time-domain baseband IQ data is sourced from one or more RF donor units 114 and/or CPRI donor units 118. The Ethernet data comprises downlink user-plane and control-plane O-RAN fronthaul data sourced from one or more O-RAN donor units 122 and/or management-plane data sourced from one or more management entities for the DAS 100. That is, this Ethernet data is encapsulated into downlink transport frames that are also used to communicate downlink time-domain baseband IQ data and this Ethernet data is also referred to here as “encapsulated” Ethernet data. The resulting downlink transport frames are communicated in the payload of downlink Ethernet packets communicated from the master unit 130 to the ICN 112 over the point-to-point Ethernet link 136. The Ethernet packets into which the encapsulated Ethernet data is encapsulated are also referred to here as “transport” Ethernet packets.

Each ICN 112 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. Any encapsulated Ethernet data that is intended for the ICN 112 (for example, management-plane Ethernet data) is processed by the ICN 112.

For each southbound point-to-point Ethernet link 136 coupled to the ICN 112, the ICN 112 assembles downlink transport frames and communicates them in downlink Ethernet packets to the southbound entities subtended from the ICN 112 via the point-to-point Ethernet link 136. For each southbound point-to-point Ethernet link 136, each downlink transport frame multiplexes together downlink time-domain baseband IQ data and Ethernet data received at the ICN 112 that needs to be communicated to those subtended southbound entities. The resulting downlink transport frames are communicated in the payload of downlink transport Ethernet packets communicated from the ICN 112 to those subtended southbound entities ICN 112 over the point-to-point Ethernet link 136.

Each RU 106 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. As described above, the RU 106 uses any downlink time-domain baseband IQ data and/or downlink O-RAN user-plane and control-plane fronthaul messages to generate downlink RF signals for radiation from the set of coverage antennas 108 associated with that RU 106. The RU 106 processes any management-plane messages communicated to that RU 106 via encapsulated Ethernet data.

Also, for any southbound point-to-point Ethernet link 136 coupled to the RU 106, the RU 106 assembles downlink transport frames and communicates them in downlink Ethernet packets to the southbound entities subtended from the RU 106 via the point-to-point Ethernet link 136. For each southbound point-to-point Ethernet link 136, each downlink transport frame multiplexes together downlink time-domain baseband IQ data and Ethernet data received at the RU 106 that needs to be communicated to those subtended southbound entities. The resulting downlink transport frames are communicated in the payload of downlink transport Ethernet packets communicated from the RU 106 to those subtended southbound entities ICN 112 over the point-to-point Ethernet link 136.

In the uplink, each RU 106 generates uplink time-domain baseband IQ data and/or uplink O-RAN user-plane fronthaul messages for each RF-interface base station 116, CPRI BBU 120, and/or O-RAN DU 124 served by that RU 106 as described above. For each northbound point-to-point Ethernet link 136 of the RU 106, the RU 106 assembles uplink transport frames and communicates them in uplink transport Ethernet packets northbound towards the appropriate master unit 130 via that point-to-point Ethernet link 136. For each northbound point-to-point Ethernet link 136, each uplink transport frame multiplexes together uplink time-domain baseband IQ data originating from that RU 106 and/or any southbound entity subtended from that RU 106 as well as any Ethernet data originating from that RU 106 and/or any southbound entity subtended from that RU 106. In connection with doing this, the RU 106 performs the combining or summing process described above for any base station 102 served by that RU 106 and also by one or more of the subtended entities. (The RU 106 forwards northbound all other uplink data received from those southbound entities.) The resulting uplink transport frames are communicated in the payload of uplink transport Ethernet packets northbound towards the master unit 130 via the associated point-to-point Ethernet link 136.

Each ICN 112 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. For each northbound point-to-point Ethernet link 136 coupled to the ICN 112, the ICN 112 assembles uplink transport frames and communicates them in uplink transport Ethernet packets northbound towards the master unit 130 via that point-to-point Ethernet link 136. For each northbound point-to-point Ethernet link 136, each uplink transport frame multiplexes together uplink time-domain baseband IQ data and Ethernet data received at the ICN 112 that needs to be communicated northbound towards the master unit 130. The resulting uplink transport frames are communicated in the payload of uplink transport Ethernet packets communicated northbound towards the master unit 130 over the point-to-point Ethernet link 136.

Each master unit 130 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. Any extracted uplink time-domain baseband IQ data, as well as any uplink O-RAN messages communicated in encapsulated Ethernet, is used in producing a single “combined” set of uplink base station signals or data for the associated base station 102 as described above (which includes performing the combining or summing process). Any other encapsulated Ethernet data (for example, management-plane Ethernet data) is forwarded on towards the respective destination (for example, a management entity).

In the exemplary embodiment shown in FIG. 1C, synchronization-plane messages are communicated using native Ethernet packets (that is, non-encapsulated Ethernet packets) that are interleaved between the transport Ethernet packets.

FIG. 1D illustrates another exemplary embodiment of a DAS 100. The DAS 100 shown in FIG. 1C is the same as the DAS 100 shown in FIG. 1C except as described below. In the exemplary embodiment shown in FIG. 1D, the CPRI donor units 118, O-RAN donor unit 122, and master unit 130 are coupled to the RUs 106 and ICNs 112 via one or more RF units 114. That is, each RF unit 114 performs the transport frame multiplexing and demultiplexing that is described above in connection with FIG. 1C as being performed by the master unit 130.

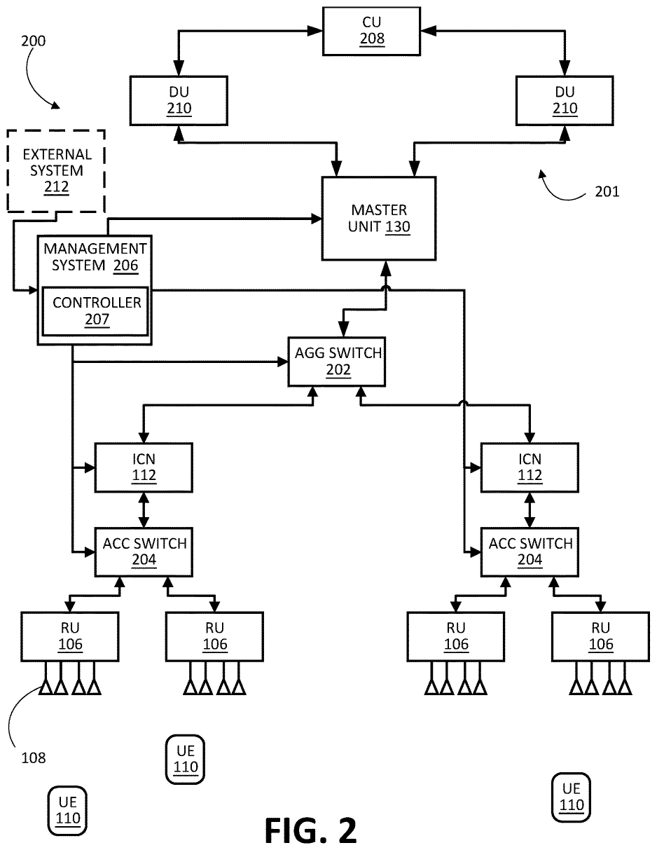

FIG. 2 illustrates another exemplary embodiment of a DAS 200. The DAS 200 shown in FIG. 2 includes similar components to the DAS 100 described above with respect to FIGS. 1A-1D. The functions, structures, and other description of common elements of the DAS 100 discussed above with respect to FIGS. 1A-1D are also applicable to like named features in the DAS 200 shown in FIG. 2. Further, the like named features included in FIGS. 1A-1D and 2 are numbered similarly. The description of FIG. 2 will focus on the differences from FIGS. 1A-1D.

In some examples, the DAS 200 is communicatively coupled to one or more base station entities 201. In the example shown in FIG. 2, the one or more base station entities 201 include one or more central units (CUs) 208 and one or more distributed units (DUs) 210. Each CU 208 implements Layer-3 and non-time critical Layer-2 functions for the associated base station. Each DU 210 is configured to implement the time critical Layer-2 functions and at least some of the Layer-1 (also referred to as the Physical Layer) functions for the associated base station. Each CU 208 can be further partitioned into one or more control-plane and user-plane entities that handle the control-plane and user-plane processing of the CU 208, respectively. Each such control-plane CU entity is also referred to as a “CU-CP,” and each such user-plane CU entity is also referred to as a “CU-UP.” In some examples, the RUs 106 are configured to implement the control-plane and user-plane Layer-1 functions not implemented by the DU 210 as well as the radio frequency (RF) functions. The RUs 106 are typically located remotely from the one or more base station entities 201. In the example shown in FIG. 2, the RUs 106 are implemented as a physical network function (PNF) and are deployed in or near a physical location where radio coverage is to be provided in the cell.

In this example, the DAS 200 is configured so that each DU 210 is configured to serve one or more RUs 106. In the particular configuration shown in FIG. 2, the two DUs 210 serve four RUs 106. Although FIG. 2 is described in the context of a 5G embodiment in which each logical base station entity is partitioned into a CU 208, DUs 210, and RUs 106 and some physical-layer processing is performed in the DU 210 with the remaining physical-layer processing being performed in the RUs 106, it is to be understood that the techniques described here can be used with other wireless interfaces (for example, 4G LTE) and with other ways of implementing a base station entity (for example, using a conventional baseband band unit (BBU)/remote radio head (RRH) architecture. Accordingly, references to a CU, DU, or RU with respect to FIG. 2 can also be considered to refer more generally to any entity (including, for example, any “base station” or “RAN” entity) implementing any of the functions or features described here as being implemented by a CU, DU, or RU.

The one or more base station entities 201 can be implemented using a scalable cloud environment in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment can be implemented in various ways. For example, the scalable cloud environment can be implemented using hardware virtualization, operating system virtualization, and application virtualization (also referred to as containerization) as well as various combinations of two or more of the preceding. The scalable cloud environment can be implemented in other ways. For example, the scalable cloud environment is implemented in a distributed manner. That is, the scalable cloud environment is implemented as a distributed scalable cloud environment comprising at least one central cloud, at least one edge cloud, and at least one radio cloud.

In some examples, the DUs 210 are implemented as software virtualized entities that are executed in a scalable cloud environment on a cloud worker node under the control of the cloud native software executing on that cloud worker node. In such examples, the DUs 210 are communicatively coupled to at least one CU-CP and at least one CU-UP, which can also be implemented as software virtualized entities, and are omitted from FIG. 2 for clarity.

In some examples, each DU 210 is implemented as a single virtualized entity executing on a single cloud worker node. In some examples, the at least one CU-CP and the at least one CU-UP can each be implemented as a single virtualized entity executing on the same cloud worker node or as a single virtualized entity executing on a different cloud worker node. However, it is to be understood that different configurations and examples can be implemented in other ways. For example, the CU 208 can be implemented using multiple CU-UP VNFs and using multiple virtualized entities executing on one or more cloud worker nodes. In another example, multiple DUs 210 (using multiple virtualized entities executing on one or more cloud worker nodes) can be used to serve a cell, where each of the multiple DUs 210 serves a different set of RUs 106. Moreover, it is to be understood that the CU 208 and DUs 210 can be implemented in the same cloud (for example, together in the radio cloud or in an edge cloud). Other configurations and examples can be implemented in other ways.

In the example shown in FIG. 2, the RUs 106 are communicatively coupled to the DUs 210 via the master unit 130, and the master unit 130 is communicatively coupled to the RUs 106 via an aggregation switch 202 and two access switches 204 communicatively coupled to the aggregation switch 202. In the exemplary embodiment shown in FIG. 2, only uplink transport data is communicated using the ICNs 112, and downlink transport data is communicated from the master unit 130 to the RUs 106 without being forwarded by, or otherwise communicated using, the ICNs 112. It should be understood that other configuration could also be used where the respective ICNs 112 forward downlink transport data to the group of southbound RUs 106 and/or ICNs 112 served by that ICN 112.

The aggregation switch 202 and the access switches 204 can be implemented as physical switches or virtual switches running in a cloud (for example, a radio cloud). In some examples, the aggregation switch 202 and the access switches 204 are SDN capable and enabled switches. In some such examples, the aggregation switch 202 and the access switches 204 are OpenFlow capable and enabled switches. In such examples, the aggregation switch 202 and the access switches 204 are configured to distribute the downlink fronthaul data packets according to forwarding rules in respective flow tables and corresponding flow entries for each respective flow table.

In some examples, multicast addressing is used for transporting downlink data from the DU 210 to the RUs 106. This is done by defining groups of RUs 106, where each group is assigned a unique multicast IP address. The switches 202, 204 in the DAS 200 are configured to support forwarding downlink data packets using those multicast IP addresses. Each such group is also referred to here as a “multicast group.” The number of RUs 106 that are included in a multicast group is also referred to here as the “size” of the multicast group.

For downlink fronthaul traffic, the aggregation switch 202 is configured to receive downlink fronthaul data packets from the master unit 130 and distribute the downlink fronthaul data packets to the RUs 106 via the access switches 204. In some examples, the aggregation switch 202 receives a single copy of each downlink fronthaul data packet from the master unit 130 for each UE 110. In some examples, each copy is segmented into IP packets that have a destination address that is set to the address of the multicast group associated with that copy. The downlink fronthaul data packet is replicated and transmitted by the aggregation switch 202 and access switches 204 as needed to distribute the downlink fronthaul data packets to the RUs 106 for the particular respective UEs 110.

While the example shown in FIG. 2 shows a single CU 208, two DUs 210, a single master unit 130, a single aggregation switch 202, two ICNs 112, two access switches 204, and four RUs 106, it should be understood that this is an example and other numbers of CUs 208, DUs 210, master units 130, aggregation switches 202 (including zero), ICNs 112, access switches 204 (including one), and/or RUs 106 can also be used.

In the example shown in FIG. 2, the master unit 130, ICNs 112, aggregation switch 202, and the access switches 204 are also communicatively coupled to a management system 206. In the example shown in FIG. 2, the management system 206 is directly coupled to the master unit 130, the aggregation switch 202, the ICNs 112, and the access switches 204. It should be understood that other configurations could also be implemented. For example, the management system 206 can also be indirectly coupled to one or more components of the DAS 200 via another component of the DAS 200. The management system 206 can be implemented in a cloud (for example, a radio cloud, an edge cloud, or a central cloud) or in one of the appliances in the radio access network (for example, in an Element Management System (EMS)). The management system 206 can include one or more controllers 207 configured to perform various functionality implemented by the management system 206. While not shown in FIGS. 1A-1D, it should be understood that the management system 206 as described herein can also be used in combination with the DAS 100 as described above with respect to FIGS. 1A-1D.

During operation, one or more active alerts may be issued that can impact operation of a DAS 100, 200. As discussed above, during emergencies (for example, E911 calls, Earthquake and Tsunami Warning System (ETWS) alerts, Commercial Mobile Alert System (CMAS) alerts, weather alerts, etc.), the needs for distribution of the traffic using a DAS and the available resources can be different from normal circumstances. In the examples described herein, the management system 206 (and controller 207) is configured to adjust operation of the DAS 100, 200 during active alerts (for example, for emergency situations) to ensure service availability with increased demand using available resources.

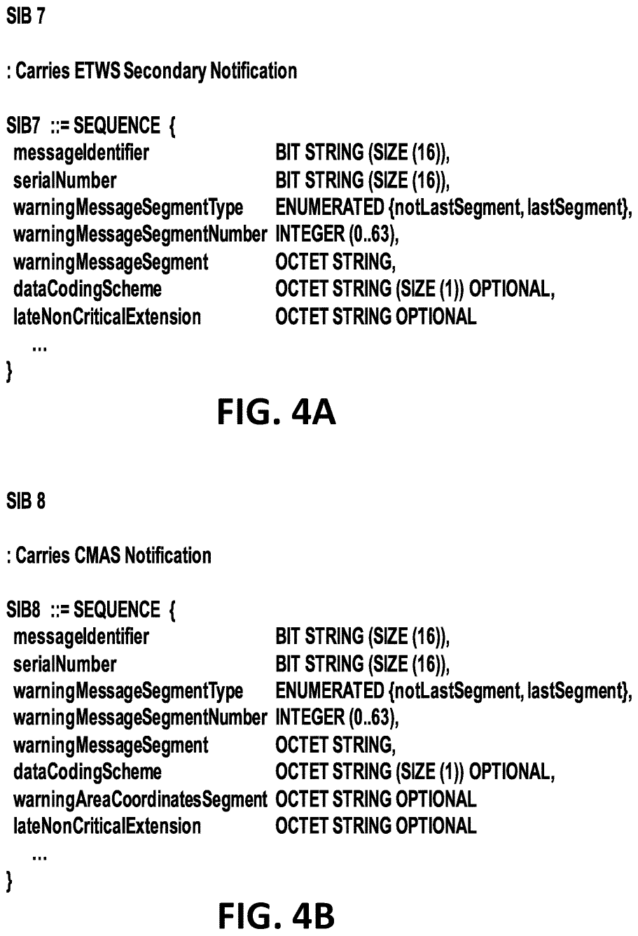

In some examples, the master unit 130 is configured to detect when there is an active alert that may impact operation of the DAS 100, 200. In such examples, the master unit 130 is configured to monitor control messages from the DU 210 for System Information Blocks (SIBs) that indicate an active alert. In some such examples, the master unit 130 is configured to monitor control messages from the DU 210 for a SIB7 (ETWS Secondary Notification) and/or a SIB8 (CMAS Notification). The contents and format of the SIB7 and the SIB8 are provided in FIGS. 4A and 4B, respectively. It should be understood that the master unit 130 can also be configured to monitor control messages from the DU 210 for other types of SIBs (for example, a SIB6 (ETWS Primary Notification)) or other types of indications of an active alert in addition to (or instead of) the SIB7 and SIB8.

In some examples, the master unit 130 is further configured to parse the SIBs for an event type. In some such examples, the master unit 130 can parse the SIB7 and/or SIB8 to determine the messageIdentifier, which identifies the source and type of notification as defined in 3rd Generation Partnership Project (3GPP) Technical Specification 23.041, which is incorporated herein by reference. When IQ compression is enabled and utilized by the DU 210 for communicating downlink data, the master unit 130 is configured to decompress the IQ data to enable parsing the SIBs for the event type. In some examples, the master unit 130 also includes, or has access to, a database that includes the various messageIdentifier codes and corresponding information regarding the source and event type, and the master unit 130 is configured to determine the event type itself from the messageIdentifier. In other examples, the master unit 130 is configured to provide the messageIdentifier from the SIB7 and/or SIB8 to the management system 206 for further processing.

In some examples, the master unit 130 is further configured to parse the SIBs for a geographical area where the active alert is valid. In some such examples, the master unit 130 can parse the SIB8 to determine the warningAreaCoordinatesSegment, which identifies the geographical area where the CMAS warning message is valid as defined in 3GPP Technical Specification 23.041. In some examples, the master unit 130 also includes, or has access to, a database that includes the various warningAreaCoordinatesSegment codes and corresponding information regarding the geographical areas, and the master unit 130 is configured to determine the geographical area itself from the warningAreaCoordinatesSegment. In other examples, the master unit 130 is configured to provide the warningAreaCoordinatesSegment from the SIB8 to the management system 206 for further processing.

In some examples, the management system 206 is configured to detect when there is an active alert that may impact operation of the DAS 100, 200, in addition to (or instead of) the master unit 130. In some such examples, the management system 206 is configured to receive an indication from one or more external systems 212 (for example, core network or emergency system) that provides information similar to that provided in the SIB7 and/or SIB8. For example, the indication from the one or more external systems 212 can identify the source, the type of notification (alert/event), and/or the geographical area where the notification is valid. In other examples, the master unit 130 is configured to forward the SIB7 and/or SIB8 to the management system 206 for parsing and determination of the type of active alert.

In some examples, the management system 206 and/or the master unit 130 is configured to determine which distribution paths within the DAS 100, 200 are impacted by the active alert using topology information and location information for the DAS 100, 200. In some examples, the topology information includes information regarding the IP addresses of the RUs 106 and a listing of the aggregation switch(es) 202, ICNs 112, and access switch(es) 204 in each respective communication path between the master unit 130 and the RUs 106. In some examples, the location information includes the physical location of the master unit 130, ICNs 112, aggregation switch 202, access switches 204, and/or RUs 106 or the hardware (for example, server or cloud infrastructure) used to implement the master unit 130, ICNs 112, aggregation switch 202, access switches 204, and/or RUs 106.

In some examples, in addition to the topology information and location information for the DAS 100, 200, the management system 206 and/or the master unit 130 determines the distribution paths within the DAS 100, 200 that are impacted by the event/alert using characteristics associated with the traffic flows from the master unit 130 to the RUs 106. For example, IP addresses for a flow, port numbers for a flow, eCPRI flow IDs, and the like can be used by the management system 206 and/or the master unit 130.

The management system 206 and/or the master unit 130 is also configured to adjust operation of one or more components of the DAS 100, 200 based on the type of active alert and the determined distribution paths within the DAS 100, 200 that are impacted by the active alert. In some examples, certain types of alerts require more adjustment to components of the DAS 100, 200 than others. For example, severe weather events (for example, wildfires, tornado, tsunami, earthquake, etc.), wars, terrorist attacks, and the like are more likely to have a significant impact on infrastructure and result in a higher volume of voice and text traffic than normal in the affected areas than another type of alert/event (for example, an amber alert). Further, in some examples, only components in distribution paths affected by the active alert (for example, where the components of the DAS 100, 200 or hardware implementing the components of the DAS 100, 200 are located in the geographical area where the alert is valid) are adjusted.

In some examples, the management system 206 and/or the master unit 130 is configured to adjust operation of one or more components of the DAS 100, 200 based on energy savings in addition to the type of alert and the determined distribution paths within the DAS 100, 200 that are impacted by the active alert. In such examples, the management system 206 and/or the master unit 130 determines or has access to energy consumption information for the components of the DAS 100, 200 (for example, in a local database or via an external system 212) and/or an amount of available energy to power the components of the DAS 100, 200.

The management system 206 and/or the master unit 130 is configured to adjust operation of one or more components of the DAS 100, 200 to increase capacity for voice and text (for example, SMS) services in areas affected by the active alert. In some examples, adjusting operation of one or more components of the DAS 100, 200 includes a determination of particular actions to take by the management system 206 and/or the master unit 130 and providing control signals to the one or more components of the DAS 100, 200 to implement the determined actions. It should be understood that the adjustment of operation for one or more components of the DAS 100, 200 can affect downlink operation, uplink operation, or both downlink operation and uplink operation.

In some examples, the management system 206 and/or the master unit 130 is configured to adjust operation of one or more components of the DAS 100, 200 to modify energy consumption in areas affected by the active alert. In some examples, adjusting operation of the one or more components of the DAS 100, 200 includes reducing energy consumption by the one or more components of the DAS 100, 200 in areas affected by the active alert. In some examples, adjusting operation of the one or more components of the DAS 100, 200 includes reducing energy consumption of one or more components of the DAS 100, 200 outside the areas affected by the active alert (for example, to free up resources for use in the areas affected by the active alert).

In some examples, the management system 206 and/or the master unit 130 is configured to adjust operation of one or more components of the DAS 100, 200 by reducing a number of layers (for example, multiple-input multiple-output layers), flows, or streams supported by various distribution paths in the DAS 100, 200. In some examples, the management system 206 and/or the master unit 130 is configured to adjust operation of one or more components of the DAS 100, 200 by turning off or reducing compute intensive resources (for example, IQ compression and combining at the ICNs 112). In some examples, the management system 206 and/or the master unit 130 is configured to adjust operation of one or more components of the DAS 100, 200 by moving one or more CNFs/VNFs to different components of the DAS 100, 200. For example, the CNFs/VNFs could be moved from components of the DAS 100, 200 in an affected distribution path to components of the DAS 100, 200 that are outside of an affected distribution path. In some examples, the management system 206 and/or the master unit 130 is configured to adjust operation of one or more components of the DAS 100, 200 by reducing a number of hops for an affected distribution path or changing the components of the DAS 100, 200 for a flow using an affected distribution path (for example, modifying the IP addresses, ports, etc.). In some examples, the management system 206 and/or the master unit 130 is configured to adjust operation of one or more components of the DAS 100, 200 by reducing or disabling one or more types of services (for example, video streaming, data services, or the like) supported by the network. In some examples, the management system 206 and/or the master unit 130 is configured to adjust operation of the one or more components of the DAS 100, 200 by shutting down the components of the DAS 100, 200. For example, the management system 206 and/or the master unit 130 is configured to shut down one or more of the RUs 106 and/or one or more ICNs 112. In some examples, the management system 206 is configured to adjust operation of the one or more components of the DAS 100, 200 by shutting down one or more master units 130.

In some examples, the management system 206 is also configured to adjust operation of one or more components of the base station 102, 201 to further reduce energy consumption of the telecommunications system that includes the DAS 100, 200 and the base station(s) 102, 201. In some such examples, the management system 206 is configured to shut down one or more CPRI BBUs 120, one or more O-RAN DUS 124, one or more CUs 208, and/or one or more DUs 210 providing capacity to the DAS 100, 200.

In some examples, the management system 206 and/or master unit 130 is configured to adjust operation of one or more components of the DAS 100, 200 based on one or more external triggers in addition to the type of alert and the determined distribution paths within the DAS 100, 200 that are impacted by the active alert. For example, the management system 206 and/or the master unit 130 can be configured to receive an indication that there has been no motion or activity around a particular RU 106 of the DAS 100, 200 for a period of time (for example, a threshold set by the operator based on desired service characteristics and performance) and shut down the particular RU 106 in response to receiving the indication. In some examples, the indication provided to the management system 206 and/or the master unit 130 is separate from the SIB7 and SIB8 and separate from the flow of channel information.

In some examples, the management system 206 and/or the master unit 130 provides control signals to the one or more components of the DAS 100, 200 via out-of-band control messaging. For example, the management system 206 can provide the control signals to the one or more components of the DAS 100, 200 using a management plane.

In some examples, the management system 206 and/or the master unit 130 only transmits control signals to the master unit 130, ICNs 112, and switches 202, 204 when a change is needed based on the active alert and the impacted distribution path(s). In some examples, the management system 206 transmits the control signals only to the components of the DAS 200 that require changes for the particular time period that the alert is valid. In other examples, the management system 206 broadcasts the updates to all of the components in the DAS 100, 200, but only those components requiring change process the updates.

In some examples, the one or more controllers 207 of the management system 206 include a SDN controller, and the aggregation switch 202 and the access switches 204 are configured using the controller 207. In such examples, the controller 207 can be configured to provide the updates to the forwarding rules for the aggregation switch 202 and/or the access switches 204 via the out-of-band control messaging.

Some alerts (for example, CMAS and ETWS alerts) are tested periodically to ensure that the systems are working as desired. For example, sirens and alerts related to tornados or tsunamis can be tested on a particular day of the month at a particular time of day when there is not an active alert. It may be desirable to avoid adjusting operation of the components of the DAS 100, 200 and base stations 102, 201 during this testing to avoid unnecessary disruptions to service.

In some examples, the telecommunications system that includes the DAS 100, 200 and the base stations 102, 201 is configured to implement one or more machine learning agent(s)/model(s) configured to predict patterns in the alerts. For example, the machine learning agent(s)/model(s) can be trained to predict the particular dates and particular times that the testing of alerts will occur. The one or more machine learning agent(s)/model(s) can be implemented in the management system 206, master unit 130, or another component of the telecommunications system.

Based on the predicted patterns in alerts, the management system 206 and/or master unit 130 determine whether to adjust operation of components of the telecommunications system. For example, if an alert is received by the management system 206 and/or the master unit 130 and corresponds to a particular day of the month at a particular time of day in the predicted pattern, then the management system 206 and/or master unit 130 is configured to not adjust operation of the components of the telecommunications system. However, if an alert is received by the management system 206 and/or the master unit 130 and does not correspond to a particular day of the month at a particular time of day in the predicted pattern, then the management system 206 and/or master unit 130 is configured to adjust operation of the components of the telecommunications system as discussed above.

In order to reliably predict the alert patterns, the machine learning agent(s)/model(s) are trained using supervised learning, unsupervised learning, reinforcement learning, and/or other machine learning methods. The machine learning agent(s)/model(s) of the machine learning computing systems are trained using online training (during operation), offline training (prior to operation), or a combination depending on the circumstances. In some examples, the machine learning agent(s)/model(s) can be trained at the CU 208, DU 210, master unit 130, and/or at a different location or locations in the network. For example, the machine learning agent(s)/model(s) can be trained offline at one location (for example, at a central server) and trained online when deployed. The machine learning agent(s)/model(s) configured to predict the pattern of alerts are trained until a prediction of the pattern of alerts can be made within acceptable margins of error. It should be understood that other techniques can also be used. For example, any of the techniques described in the O-RAN Working Group (WG) 2 Artificial Intelligence (AI) Machine Learning (ML) Technical Report (O-RAN.WG2.AIML-v01.03) (referred to herein as the “O-RAN AIML Technical Report”), which is incorporated herein by reference, can be used for training and deployment of the machine learning agent(s)/model(s).

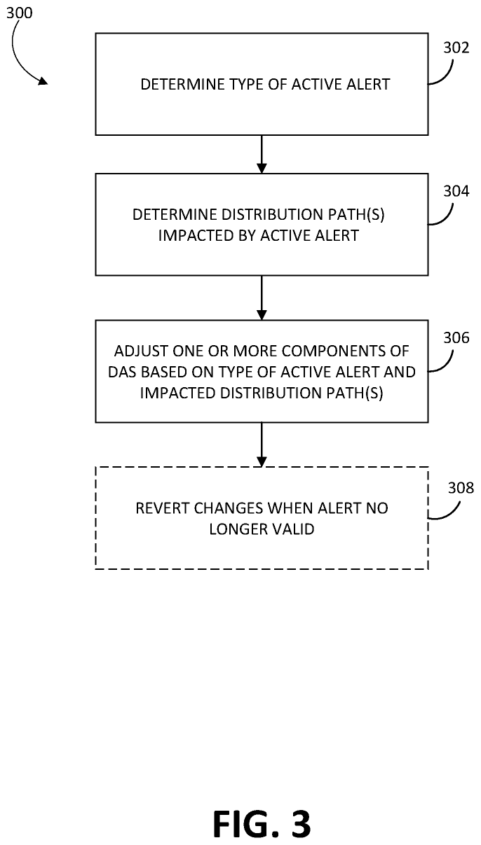

FIG. 3 illustrates a flow diagram of an example method 300 for alert management in a DAS. The common features discussed above with respect to the base stations in FIGS. 1A-2 can include similar characteristics to those discussed with respect to method 300 and vice versa.

The blocks of the flow diagram in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel in an event-driven manner).

The method 300 includes determining a type of active alert impacting the DAS (block 302). In some examples, a master unit of the DAS is configured to determine a type of active alert impacting the DAS by monitoring control messages for a SIB7 and/or SIB8. In some such examples, the master unit can be configured to parse the SIB7 and/or SIB8 for an event type or to forward the SIB7 and/or SIB8 to the management system for parsing. In some examples, in addition to (or instead of) the master unit monitoring control messages, a management system is configured to receive an indication of the type of active alert from an external system (for example, the core network, weather service, etc.).

The method 300 further includes determining one or more distribution paths impacted by the active alert (block 304). In some examples, the master unit of the DAS and/or the management system is configured to determine the distribution paths impacted by the active alert using topology and location information for the DAS and characteristics of traffic flows from the master unit to the RUs.

The method 300 further includes adjusting one or more components of the DAS based on the determined type of active alert and the determined one or more distribution paths impacted by the active alert (block 306). In some examples, adjusting one or more components of the DAS includes determining actions to take based on the type of active alert and impacted distribution paths and providing control signals to the one or more components of the DAS to implement the actions (changes).

The method 300 optionally includes reverting changes when the alert impacting the DAS is no longer valid (block 308). In some examples, the management system and/or master unit is configured to provide control signals to the one or more components of the DAS to undue the adjustments once an indication that the alert is no longer valid is received by the management system and/or master unit.

By using the techniques described herein, a system that utilizes a DAS to distribute baseband signals can ensure service availability for voice and text messages during emergency events (for example, ETWS or CMAS alerts) even with increased demand on the network. Further, using the techniques described herein, the energy consumption of a system that utilizes a DAS to distribute baseband signals can be reduced by adjusting operation of one or more components of the DAS and/or the base station.

While the techniques described herein are specifically discussed with respect to a system that utilizes a DAS to distribute baseband signals, it should be understood that the techniques for determining active alert types, impacted paths, and adjusting operation of components is also applicable to other types of telecommunications systems. For example, the techniques could be used for a small cell deployment that utilizes radio points distributed throughout a cell.

### EXAMPLE EMBODIMENTS

Example 1 includes a method, comprising: determining a type of active alert for a distributed antenna system; determining one or more paths of the distributed antenna system impacted by the active alert; and adjusting operation of one or more components of the distributed antenna system based on the determined type of active alert and the determined one or more paths of the distributed antenna system impacted by the active alert.

Example 2 includes the method of Example 1, wherein determining the type of active alert for the distributed antenna system includes monitoring control messages for at least one System Information Block (SIB), wherein the at least one SIB includes a SIB7 and/or a SIB8, wherein determining the type of active alert for the distributed antenna system includes parsing the at least one SIB for an event type.

Example 3 includes the method of any of Examples 1-2, wherein adjusting operation of the one or more components of the distributed antenna system is further based on an amount of energy savings.

Example 4 includes the method of any of Examples 1-3, wherein determining the type of active alert for the distributed antenna system includes obtaining the type of active alert from an external system, wherein the external system is separate from the distributed antenna system.

Example 5 includes the method of any of Examples 1-4, wherein determining one or more paths of the distributed antenna system impacted by the active alert includes using topology information for the distributed antenna system, location information for nodes of the distributed antenna system, and characteristics of one or more flows supported by the distributed antenna system.

Example 6 includes the method of any of Examples 1-5, wherein the distributed antenna system includes a master unit communicatively coupled to and located remotely from a plurality of radio units, wherein the master unit is communicatively coupled to the plurality of radio units via one or more switches, wherein adjusting operation of one or more components of the distributed antenna system based on the determined type of active alert and the determined one or more paths of the distributed antenna system impacted by the active alert includes: determining one or more modifications for the master unit, the one or more switches, and/or the plurality of radio units based on the type of active alert and the determined one or more paths of the distributed antenna system impacted by the active alert; and providing control signals to the master unit, the one or more switches, and/or the plurality of radio units to implement the one or more modifications.

Example 7 includes the method of any of Examples 1-6, wherein adjusting operation of the one or more components of the distributed antenna system is further based on an indication of whether there is motion in proximity to the one or more components.

Example 8 includes the method of any of Examples 1-7, adjusting operation of one or more components of the distributed antenna system includes: reducing a number of layers, flows, or streams supported by various distribution paths in the distributed antenna system; turning off or reducing compute intensive resources performed by the one or more components of the distributed antenna system; moving one or more network functions from a component of the distributed antenna system in a distribution path impacted by the active alert to a different component of the distributed antenna system that is not in a distribution path impacted by the active alert; reducing a number of hops for a distribution path impacted by the active alert; changing components of the distributed antenna system in a flow using a distribution path impacted by the active alert; reducing or disabling one or more types of services supported by the distributed antenna system; and/or shutting down the one or more components of the distributed antenna system.

Example 9 includes the method of any of Examples 1-8, further comprising reverting the operation of the one or more components of the distributed antenna system after the active alert is no longer valid.

Example 10 includes a system, comprising: a master unit of a distributed antenna system, wherein the master unit is configured to be coupled to one or more baseband unit entities; a plurality of radio units of the distributed antenna system communicatively coupled to the master unit, wherein the plurality of radio units is located remotely from the master unit; and at least one controller communicatively coupled to the master unit and the plurality of radio units; wherein one or more components of the system are configured to: determine a type of active alert for the distributed antenna system; determine one or more distribution paths of the distributed antenna system impacted by the active alert; and adjust operation of one or more components of the distributed antenna system based on the determined type of active alert and the determined one or more paths of the distributed antenna system impacted by the active alert.

Example 11 includes the system of Example 10, wherein the master unit is configured to determine the type of active alert for the distributed antenna system.

Example 12 includes the system of Example 11, wherein the master unit is configured to monitor control messages from the one or more baseband unit entities for at least one System Information Block (SIB), wherein the master unit is configured to parse the at least one SIB for the type of active alert.

Example 13 includes the system of any of Examples 10-12, wherein the one or more components of the system are further configured to implement one or more machine learning models configured to predict patterns in alerts for the distributed antenna system, wherein the one or more components of the system are configured to adjust operation of one or more components of the distributed antenna system based on the determined type of active alert, the determined one or more paths of the distributed antenna system impacted by the active alert, and the predicted patterns in alerts for the distributed antenna system.

Example 14 includes the system of any of Examples 10-13, wherein the one or more components of the system are further configured to adjust operation of one or more components of the one or more baseband unit entities based on an amount of energy savings.

Example 15 includes the system of any of Examples 10-14, wherein the at least one controller is configured to determine the type of active alert for the distributed antenna system.

Example 16 includes the system of Example 15, wherein the at least one controller is configured to receive an indication from an external system that includes the type of active alert, wherein the external system is separate from the distributed antenna system.

Example 17 includes the system of any of Examples 10-16, wherein the master unit or the at least one controller is configured to determine the one or more distribution paths of the distributed antenna system impacted by the active alert using topology information for the distributed antenna system, location information for nodes of the distributed antenna system, and characteristics of one or more flows supported between the master unit and the plurality of radio units.

Example 18 includes the system of any of Examples 10-17, wherein the master unit is communicatively coupled to the plurality of radio units via one or more switches, wherein the one or more components of the system are configured to adjust operation of one or more components of the distributed antenna system by: determining one or more modifications for the master unit, the one or more switches, and/or the plurality of radio units based on the type of active alert and the determined one or more paths of the distributed antenna system impacted by the active alert; and providing control signals to the master unit, the one or more switches, and/or the plurality of radio units to implement the one or more modifications.

Example 19 includes the system of any of Examples 10-18, wherein the one or more components of the system are further configured to adjust operation of one or more components of the distributed antenna system based on an amount of energy savings.

Example 20 includes the system of any of Examples 10-19, wherein the one or more components of the system are configured to adjust operation of one or more components of the distributed antenna system by: reducing a number of layers, flows, or streams supported by various distribution paths in the distributed antenna system; turning off or reducing compute intensive resources performed by the one or more components of the distributed antenna system; moving one or more network functions from a component of the distributed antenna system in a distribution path impacted by the active alert to a different component of the distributed antenna system that is not in a distribution path impacted by the active alert; reducing a number of hops for a distribution path impacted by the active alert; changing components of the distributed antenna system in a flow using a distribution path impacted by the active alert; reducing or disabling one or more types of services supported by the system; and/or shutting down the one or more components of the distributed antenna system.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A method, comprising:
determining a type of active alert for a distributed antenna system;
determining one or more paths of the distributed antenna system impacted by the active alert; and
adjusting operation of one or more components of the distributed antenna system based on the determined type of active alert and the determined one or more paths of the distributed antenna system impacted by the active alert.

2. The method of claim 1, wherein determining the type of active alert for the distributed antenna system includes monitoring control messages for at least one System Information Block (SIB), wherein the at least one SIB includes a SIB7 and/or a SIB8, wherein determining the type of active alert for the distributed antenna system includes parsing the at least one SIB for an event type.

3. The method of claim 1, wherein adjusting operation of the one or more components of the distributed antenna system is further based on an amount of energy savings.

4. The method of claim 1, wherein determining the type of active alert for the distributed antenna system includes obtaining the type of active alert from an external system, wherein the external system is separate from the distributed antenna system.

5. The method of claim 1, wherein determining one or more paths of the distributed antenna system impacted by the active alert includes using topology information for the distributed antenna system, location information for nodes of the distributed antenna system, and characteristics of one or more flows supported by the distributed antenna system.

6. The method of claim 1, wherein the distributed antenna system includes a master unit communicatively coupled to and located remotely from a plurality of radio units, wherein the master unit is communicatively coupled to the plurality of radio units via one or more switches, wherein adjusting operation of one or more components of the distributed antenna system based on the determined type of active alert and the determined one or more paths of the distributed antenna system impacted by the active alert includes:
determining one or more modifications for the master unit, the one or more switches, and/or the plurality of radio units based on the type of active alert and the determined one or more paths of the distributed antenna system impacted by the active alert; and
providing control signals to the master unit, the one or more switches, and/or the plurality of radio units to implement the one or more modifications.

7. The method of claim 1, wherein adjusting operation of the one or more components of the distributed antenna system is further based on an indication of whether there is motion in proximity to the one or more components.

8. The method of claim 1, adjusting operation of one or more components of the distributed antenna system includes:
reducing a number of layers, flows, or streams supported by various distribution paths in the distributed antenna system;
turning off or reducing compute intensive resources performed by the one or more components of the distributed antenna system;
moving one or more network functions from a component of the distributed antenna system in a distribution path impacted by the active alert to a different component of the distributed antenna system that is not in a distribution path impacted by the active alert;
reducing a number of hops for a distribution path impacted by the active alert;
changing components of the distributed antenna system in a flow using a distribution path impacted by the active alert;
reducing or disabling one or more types of services supported by the distributed antenna system; and/or
shutting down the one or more components of the distributed antenna system.

9. The method of claim 1, further comprising reverting the operation of the one or more components of the distributed antenna system after the active alert is no longer valid.

10. A system, comprising:
a master unit of a distributed antenna system, wherein the master unit is configured to be coupled to one or more baseband unit entities;
a plurality of radio units of the distributed antenna system communicatively coupled to the master unit, wherein the plurality of radio units is located remotely from the master unit; and
at least one controller communicatively coupled to the master unit and the plurality of radio units;
wherein one or more components of the system are configured to:
determine a type of active alert for the distributed antenna system;
determine one or more distribution paths of the distributed antenna system impacted by the active alert; and
adjust operation of one or more components of the distributed antenna system based on the determined type of active alert and the determined one or more paths of the distributed antenna system impacted by the active alert.

11. The system of claim 10, wherein the master unit is configured to determine the type of active alert for the distributed antenna system.

12. The system of claim 11, wherein the master unit is configured to monitor control messages from the one or more baseband unit entities for at least one System Information Block (SIB), wherein the master unit is configured to parse the at least one SIB for the type of active alert.

13. The system of claim 10, wherein the one or more components of the system are further configured to implement one or more machine learning models configured to predict patterns in alerts for the distributed antenna system, wherein the one or more components of the system are configured to adjust operation of one or more components of the distributed antenna system based on the determined type of active alert, the determined one or more paths of the distributed antenna system impacted by the active alert, and the predicted patterns in alerts for the distributed antenna system.

14. The system of claim 10, wherein the one or more components of the system are further configured to adjust operation of one or more components of the one or more baseband unit entities based on an amount of energy savings.

15. The system of claim 10, wherein the at least one controller is configured to determine the type of active alert for the distributed antenna system.

16. The system of claim 15, wherein the at least one controller is configured to receive an indication from an external system that includes the type of active alert, wherein the external system is separate from the distributed antenna system.

17. The system of claim 10, wherein the master unit or the at least one controller is configured to determine the one or more distribution paths of the distributed antenna system impacted by the active alert using topology information for the distributed antenna system, location information for nodes of the distributed antenna system, and characteristics of one or more flows supported between the master unit and the plurality of radio units.

18. The system of claim 10, wherein the master unit is communicatively coupled to the plurality of radio units via one or more switches, wherein the one or more components of the system are configured to adjust operation of one or more components of the distributed antenna system by:
determining one or more modifications for the master unit, the one or more switches, and/or the plurality of radio units based on the type of active alert and the determined one or more paths of the distributed antenna system impacted by the active alert; and
providing control signals to the master unit, the one or more switches, and/or the plurality of radio units to implement the one or more modifications.

19. The system of claim 10, wherein the one or more components of the system are further configured to adjust operation of one or more components of the distributed antenna system based on an amount of energy savings.

20. The system of claim 10, wherein the one or more components of the system are configured to adjust operation of one or more components of the distributed antenna system by:
reducing a number of layers, flows, or streams supported by various distribution paths in the distributed antenna system;
turning off or reducing compute intensive resources performed by the one or more components of the distributed antenna system;
moving one or more network functions from a component of the distributed antenna system in a distribution path impacted by the active alert to a different component of the distributed antenna system that is not in a distribution path impacted by the active alert;
reducing a number of hops for a distribution path impacted by the active alert;
changing components of the distributed antenna system in a flow using a distribution path impacted by the active alert;
reducing or disabling one or more types of services supported by the system; and/or
shutting down the one or more components of the distributed antenna system.
